(19) United States
(12) Patent Application Publication
(10) Pub. No.: US 2006/0101358 A1
(43) Pub. Date: May 11, 2006

(54) Circuit design simulation

(76) Inventors: Gauray Rameshbhai Shah, Caldwell, ID (US); Denise Susan Man, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/975,145

(22) Filed: Oct. 28, 2004

(51) Int. Cl. G06F 17/50; G06G 7/62

(52) U.S. Cl. 716/4; 703/13

(57) ABSTRACT

Various approaches for simulating a circuit design are described. In one approach, charge-holding combinations of connected circuit components in a non-hierarchical representation of a circuit design are identified as known circuit components. Each identification is made as a function of characterized responses of the combinations. Identification information of the known circuit components is stored in association with the identified charge-holding combinations. For each of the identified charge-holding combinations, sub-combinations of circuit components therein that implement a known circuit are identified, and identification information of the known circuits is stored in association with the identified sub-combinations. Hierarchical relationships between the identified charge-holding combination and each sub-combination of the charge-holding combination are identified and data describing the hierarchical relationships is stored.

### BACKGROUND

Circuit designs are generally created and implemented using tools that generate information that is stored in one or more data storage arrangements. Storing circuit design information typically involves storing sufficient information for each design component that identifies characteristics and connectivity for all components in the circuit design. For instance, many typical circuit designs employ a multitude of FETs (field-effect transistors) and NETs (information describing the connectivity of the FETs) that, when connected in certain arrangements, define functional circuits. These FETs and NETs are typically arranged with a hierarchical relationship, with different FETs and NETs being attributed to a multitude of blocks and sub-blocks (or child blocks) that define the circuit design.

The functional circuits that combinations of FETs make up can be generally characterized, e.g., as known circuits having certain components that, when provided with certain inputs, produce an expected response. In this regard, a variety of known circuits can be characterized as a combination of circuit components connected in a particular manner. For instance, an inverter or latch can be characterized as a combination of smaller circuit components (i.e., FETs) that responds to inputs in a predictable manner.

Once circuit design information is stored, simulation tools can access the design information for simulation purposes (e.g., analysis and testing). For example, circuit recognition and verification are two approaches that involve access to stored design data for simulation purposes. Some of these purposes include identifying components and connectivity for a design (circuit recognition) and verifying the operation of the design under certain conditions (circuit verification). Typically, circuit design information is input in the form of a netlist, analyzed and its logical circuit classification is output. Simulation tools use this logical circuit classification in simulating operation of the logical circuit.

Tools used to simulate circuits typically must supply information for identifying a hierarchical location of a particular circuit design component in order to retrieve the component. For example, when information about a particular functional circuit such as a latch is needed, the tool has been typically required to provide information indicative of the hierarchical location of the functional circuit. This location information typically includes the name and path of the block containing the functional circuit. In this regard, a fairly significant degree of information about the functional circuit or, more generally, about the circuit design being simulated, must be known before simulation can be carried out. In addition, simulation tools are limited in accessing a particular type of component in a circuit design; tools generally need to specify a design component by location, rather than name.

The above and other difficulties associated with access to circuit design data have presented challenges to circuit design simulation.

### SUMMARY

The various embodiments of the invention provide various approaches for simulating a circuit design are described. In one embodiment, charge-holding combinations of connected circuit components in a non-hierarchical representation of a circuit design are identified as known circuit components. Each identification is made as a function of characterized responses of the combinations. Identification information of the known circuit components is stored in association with the identified charge-holding combinations. For each of the identified charge-holding combinations, sub-combinations of circuit components therein that implement a known circuit are identified, and identification information of the known circuits is stored in association with the identified sub-combinations. Hierarchical relationships between the identified charge-holding combination and each sub-combination of the charge-holding combination are identified and data describing the hierarchical relationships is stored.

It will be appreciated that various other embodiments are set forth in the Detailed Description and claims that follow.

### BRIEF DESCRIPTION OF THE DRAWINGS

FIG. 1A is a flow diagram for an approach to simulating a circuit design, according to an example embodiment of the present invention;

FIG. 1B is a flow diagram for an approach to simulating a circuit design, according to another example embodiment of the present invention;

FIG. 2 is a flow diagram for an approach to simulating a circuit design using a functional hierarchical relationship between circuit design components, according to an example embodiment of the present invention; and

FIG. 3 shows a circuit design simulation arrangement, according to another example embodiment of the present invention.

### DETAILED DESCRIPTION

The various embodiments of the invention described herein relate to simulation of a circuit design. According to one embodiment, a circuit design representation characterized by hierarchical relationships between individual circuit components (e.g., a design representation in the form of a netlist having blocks and sub-blocks) is flattened. This flattening approach, sometimes referred to as exploding, generally transforms the circuit design into a representation characterized by individual circuit components (i.e., FETs) electrically coupled to one another (i.e., as defined by NETs). The flattening approach removes the hierarchical relationships in the original design that typically do not recognize functional groupings of circuit components (e.g., functional circuit components, such as an inverter, are not grouped and may cross block boundaries).

After flattening, components of the circuit design are grouped into functional combinations that represent a functional circuit amenable to (function-based) identification that characterizes the groups by a known function that the group performs, such as latch, domino or multiplexer functions. Hierarchical relationships are re-defined as a function of the circuit-function-based identification such that functional sub-components (e.g., inverters) making up a functional parent component (e.g., a latch) are hierarchically related.

The functional combinations are stored in a manner that facilitates retrieval of information regarding the combinations by specifying the identification of a combination and/or of the functional parent component to which a combination belongs. This information retrieval can be carried out without necessarily supplying a hierarchical location of the functional combinations (e.g., without supplying a design block name and path), or by specifying the functional component name along with function-related hierarchical information.

Once circuit design information including functional classification (or classifications) for a particular design has been stored, the information is made accessible for use with a variety of approaches. For instance, when information regarding a particular type of functional circuit of a portion of a circuit design is required, an application programming interface (API) call specifying the type of functional circuit can be used for retrieving the information. The API call may specify, for example, all functional circuits matching the identified type of functional circuit in a particular circuit category. For example, this API (or other) call can be made across an entire design (returning all matching functional circuits) and/or to a particular location in the design. In the latter case, only matching functional circuits from the particular location are returned. In other implementations, hierarchical information is used in making the API call, with a call applied to a parent component generating the return of information for identified functional components hierarchically belonging to the parent component.

In some applications, the components of the circuit design are grouped into functional combinations by observing the response of component groups under certain operating conditions. For instance, where a particular group holds a charge and responds to inputs (e.g., a “1” or a “0”) in accordance with the known operation of a particular known circuit, the group can be identified as the known component. In this regard, channel-connected regions can be identified from a netlist and these regions can be monitored under different input conditions. The response to inputs can be characterized using characteristics including, for example, output type and path and compared to expected responses of known circuits such as a pass gate, a pseudo-nMOS or a latch with a driver. Such a grouping of components can be identified as a “parent” circuit with other components making up the parent circuit being “child” components. These child components may have additional sub-child components, together identifying a hierarchy that extends down to a single circuit component, such as a FET. As an example hierarchical approach, a “parent” inverter circuit may include “child” circuits that are latches, which in turn include sub-child components that are FETs.

In another example embodiment of the present invention, a circuit design interface arrangement (interface) is configured and arranged to respond to an application programming interface (API) call specifying a functional circuit type by returning circuit design information. The interface processes functional circuit identification data in the API call to retrieve information for groups of circuit design components characterized by the functional circuit identification. For example, where a VLSI type structure, such as a latch, is part of a particular circuit design, the latch is typically made up of sub-components including inverters. In this regard, the interface is adapted not only to return information for a particular VLSI type structure; the interface is also adapted to return information for functional sub-components of the VLSI structure. Using a latch circuit as an example parent structure, the interface is adapted to return information for the FETs that make up the latch as well as information for groupings of the FETs that make up latch sub-structures (inverters).

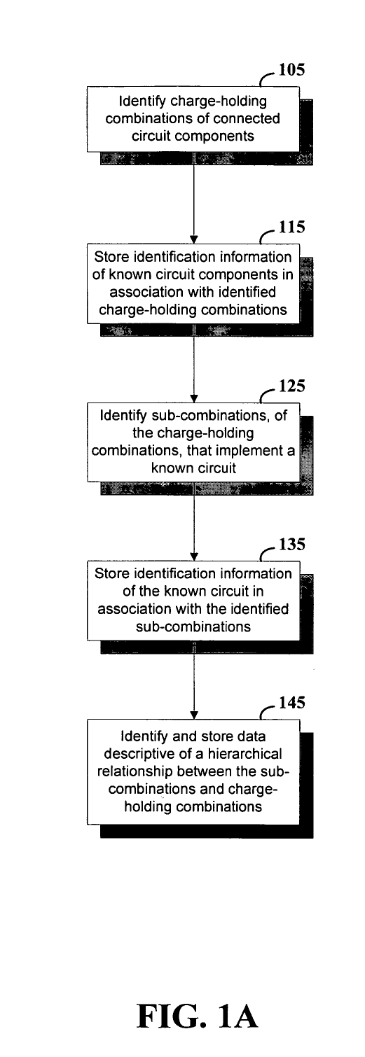

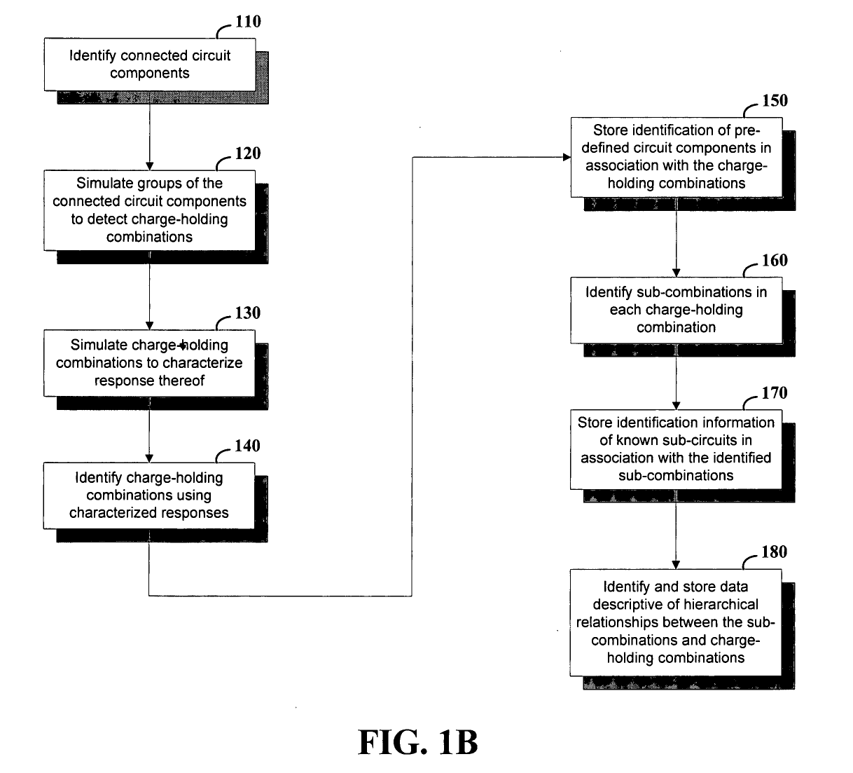

Turning now to the figures, FIG. 1A shows a flow diagram for an approach to circuit simulation, according to another example embodiment of the present invention. At block 105, charge-holding combinations of connected circuit components in a non-hierarchical representation of a circuit design are identified as known circuit components. This identification is carried out as a function of characterized responses of the combinations (e.g., to input signals such as test vectors). At block 115, identification information of the known circuit components is stored in association with the identified charge-holding combinations. For each of the identified charge-holding combinations, sub-combinations of circuit components therein that implement a known circuit are identified at block 125, and identification information of the known circuits are stored in association with the identified sub-combinations at block 135. At block 145, data descriptive of a hierarchical relationship between each identified charge-holding combination and each sub-combination of the charge-holding combination is identified and stored.

FIG. 1B shows a flow diagram for an approach to circuit design simulation, according to another example embodiment of the present invention. At block 110, connected circuit components (e.g., channel-connected components such as transistors having their source/drain regions connected) in a non-hierarchical representation of a circuit design are identified. Groups of the identified connected circuit components are simulated at block 120, and combinations of the connected circuit components that hold charge are detected and identified as charge-holding combinations. Each of the charge-holding combinations is simulated at block 130 to characterize responses of the charge-holding combinations under a plurality of operating conditions. Each of the charge-holding combinations is identified as a pre-defined circuit component as a function of the characterized responses at block 140, and identification information of the pre-defined circuit components is stored in association with the identified charge-holding combinations at block 150. At block 160, and for each of the identified charge-holding combinations, sub-combinations of circuit components therein that implement a known sub-circuit are identified. Identification information of the known sub-circuits is stored in association with the identified sub-combinations at block 170. Data descriptive of a hierarchical relationship between each identified charge-holding combination and each sub-combination of the charge-holding combination is identified and stored at block 180.

The simulation discussed in connection with FIG. 1B above and elsewhere is carried out using one or more of a variety of approaches, depending upon the application. In one implementation, a series of test vectors are input to the portion (i.e., circuit combination) of the design being simulated. The test vectors include signals known to generate a particular response from known circuits. When the particular response to the test vectors is observed from a circuit combination, that circuit combination is characterized as the known circuit for which the particular response is expected.

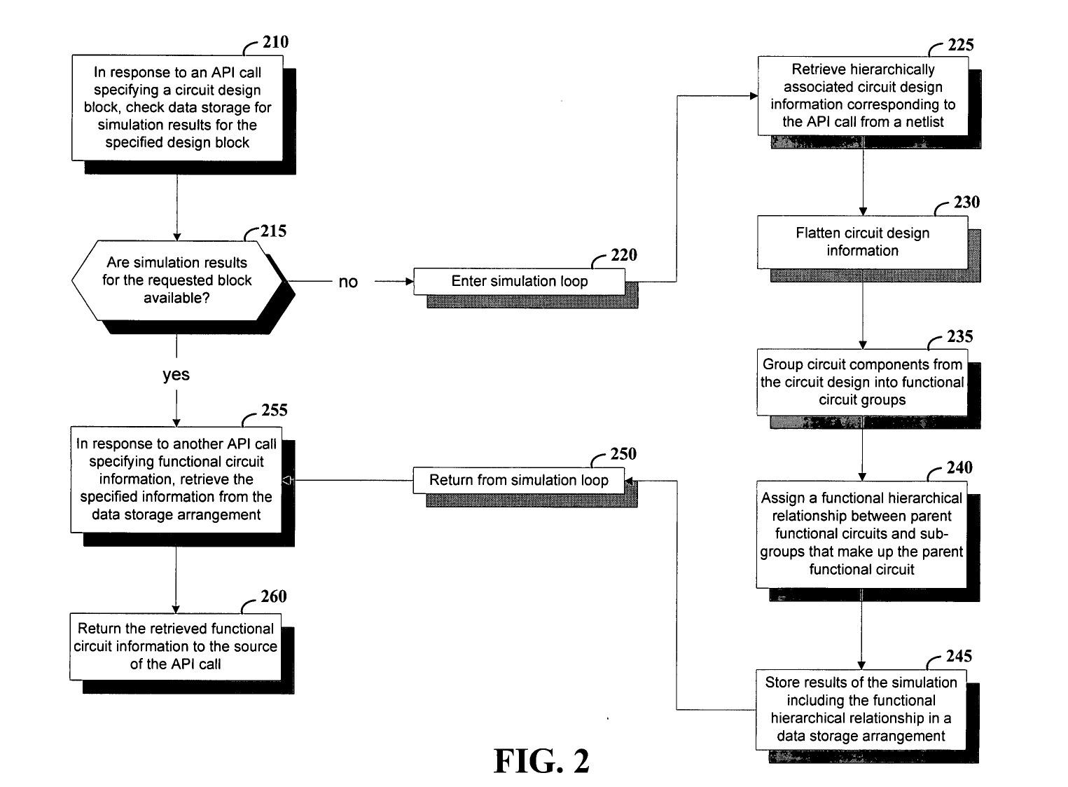

FIG. 2 is a flow diagram for an approach to simulating a circuit design using a functional hierarchical relationship between circuit design components, according to an example embodiment of the present invention. At block 210, a data storage arrangement is checked for simulation results in response to an API call specifying a design block. If simulation results are available at block 215, the process continues at block 255 as described further below.

If simulation results for the requested block are not available at block 215, a simulation loop is entered at block 220. Hierarchically associated circuit design information corresponding to the API call received at block 210 is retrieved from a netlist at block 225. The API call typically specifies a location (i.e., block name and path) that is used when retrieving the block at block 225; this retrieval is generally independent from functional characteristics of the design block. The retrieved circuit design information is flattened at block 230, and components of the circuit design are grouped into functional circuit groups at block 235.

A functional hierarchical relationship between parent functional circuits and sub-groups that make up the parent functional circuit are assigned at block 240. The hierarchical relationship is assigned according to the functional application of the circuits, such that smaller circuit components that make up a larger component are hierarchically related to indicate so. Using the example discussed above, a latch circuit made up of two inverters would thus be hierarchically classified with the latch being the parent, and the inverters being the sub-structures of the parent. In this regard, individual circuit components (e.g., FETs) under the parent latch would be identifiable (and distinguishable) as a function of their relationship with the latch as being inverters that belong to the latch. Results of the simulation, including information identifying the functional hierarchical relationships, are stored in a data storage arrangement at block 245. At block 250, the process returns from the simulation loop for further responding to API calls.

At block 255, in response to another API call specifying functional circuit information, the specified information is retrieved from the data storage arrangement. Using the above example with a parent latch and sub-structure inverters, an API call received at block 255 identifying a block in which the latch resides and requesting all inverters that make up latches, the latch information is retrieved. At block 260, the retrieved functional circuit information is returned to the source (e.g., tool) making the API call. This approach facilitates the specific retrieval of information for functionally grouped circuit components. In this regard, API calls can be made at a level of specificity such that function-based calls, rather than location-based calls, can be made for a circuit design.

In one implementation, the simulation loop entered at block 220 includes building blocks of the grouped circuit components 235 for which functional hierarchical relationships have been assigned at block 240. For example, where a relatively large portion of a circuit design is simulated, it may be desirable to sub-divide the circuit design into components for processing, accessibility or other purposes. In this regard, different blocks are formed, arbitrarily, functionally or relative to blocks in the netlist, in connection with blocks 235 and 240. The blocks are accordingly stored with the results of the simulation at block 245 and used upon subsequent API calls at block 255.

In another implementation, the API call made at block 210 includes information for two or more blocks of a circuit design and may further include a call for an entire circuit design. Once the design has been simulated (flattened, functionally grouped and hierarchically related), access to any portion of the design is carried out using function-specific API calls. In this regard, circuit-function based API calls can be made across the entire circuit design or for portions of the circuit design (e.g., a call can be made for all the latches in a particular block, rather than all the blocks that contain latches).

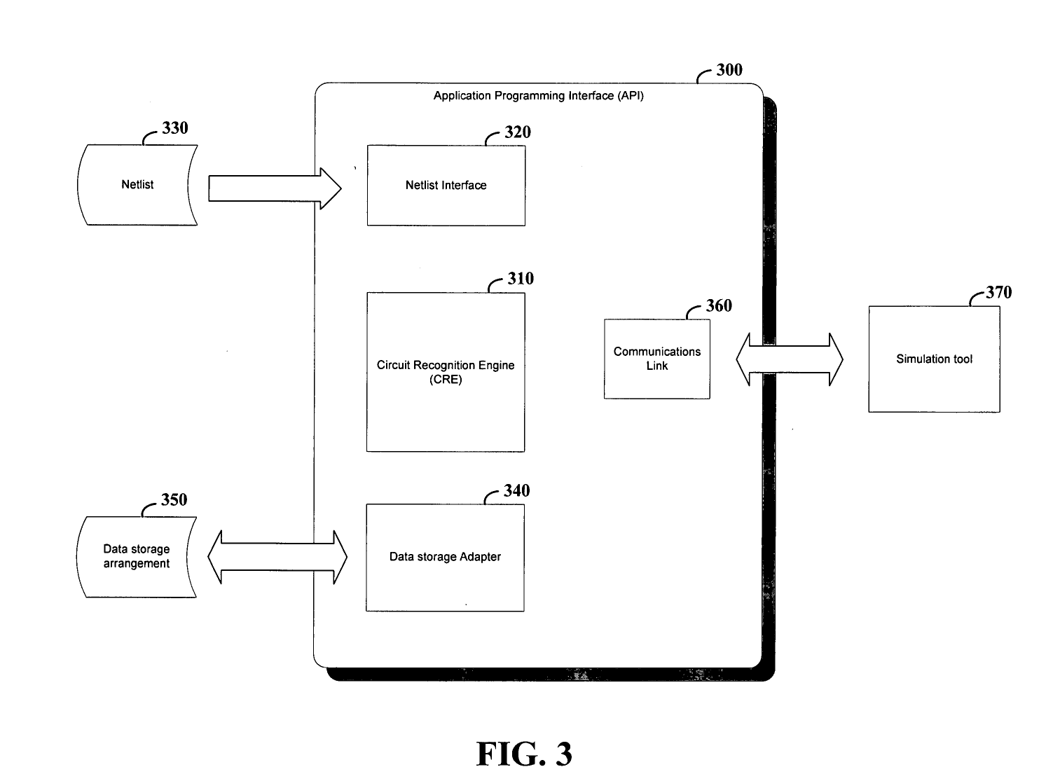

FIG. 3 shows a circuit design simulation arrangement 300 including a application programming interface (API) 300 adapted for functional, hierarchical classification of circuit design components, according to another example embodiment of the present invention. The API 300 includes a CRE 310 for simulating a circuit design in response to inputs (API calls) from one or more simulation tools 370. The API 300 further includes a netlist interface 320 adapted to interact with a netlist 330, shown here by way of example and optionally implemented with a plurality of netlists, for retrieving netlist data for a circuit design. A database adapter 340 interfaces with a data storage arrangement 350 for storing and retrieving simulated circuit design data processed by the CRE 310.

The netlist 330 typically includes a hierarchical classification of circuit designs that includes blocks and nets, the blocks including one or more circuit elements and the nets describing the interconnection of the circuit elements and/or blocks. This hierarchical classification in the netlist 330 typically does not describe any grouping of the interconnected circuit elements that make up functional circuits (e.g., well-known circuits such as inverters, latches, dominos or multiplexers, or customer-specific circuits). In this regard, the CRE 310 processes retrieved circuit design blocks to functionally classify the blocks or components thereof. The functional classification describes functional characteristics of groups of circuit elements in the block when implemented together in a manner that is useful for simulating the circuit design block.

The CRE 310 may be implemented in one or more of a variety of manners, such as those discussed above in connection with FIG. 1B and otherwise. In some instances, the CRE 310 executes simulation that may involve a circuit recognition-type function in which characteristics of a circuit being simulated are identified for facilitating the simulation. For example, where a particular circuit design block is to be analyzed, the block is retrieved from the netlist 330 via netlist interface 320 and partitioned into functional circuits that include a combination of circuit elements (e.g., a combination of FETs). These partitions are analyzed to determine a logical circuit classification (or classifications) that characterize the partition (i.e., the circuit type of the combination is recognized (circuit recognition)). These classifications include a functional description of the combination of individual circuit elements that function together to make a particular functional circuit. Various simulation functions, such as those implemented to determine circuit timing characteristics, circuit impedance and others can then be carried out using the circuit recognition results.

In one particular implementation, data retrieved from the netlist 330 is flattened and grouped into functional circuits by the CRE 310, with the groups being functionally classified (named) using a known identification of a functional circuit (e.g., using identifications such as a latch, domino or multiplexer to identify functional circuits). The CRE 310 further identifies functional hierarchical relationships between functional circuits and identifies the hierarchical relationships (e.g., identifies sub-components such as inverters that combine to make parent components such as latches). The data simulated at the CRE 310, along with any corresponding hierarchical information as defined functionally by the CRE 310, is stored in the data storage arrangement 350 using the data storage adapter 340. In addition, this hierarchical information can identify different hierarchical characteristics, relative to that typically characterized in netlist information (i.e., functional hierarchy, rather than block hierarchy, can be identified).

After the simulated and functionally classified information is stored, subsequent API calls from the simulation tool 370 can be processed to retrieve and return data from the data storage arrangement 350. Such subsequent API calls may include, for example, functional hierarchy information identifying the type of data to be retrieved.

The data storage arrangement 350 may be implemented using one or more of a variety of storage approaches, such as an XML (extensible markup language) or SQL (structured query language) approach. In addition, the data storage arrangement 350 can be implemented either locally to the API 300 or remotely, with access to the data storage arrangement 350 being via one or more of a variety of communication links. For instance, the API 300 and data storage arrangement 350 may be coupled to network communications link, such as an Internet protocol (IP) link, with the API and the data storage arrangement being assigned addresses on the link. Other components in the arrangement 300 (and accordingly the netlist 330 or simulation tool 370) may also be coupled via network or other communications links and thus are not necessarily local in nature.

In one implementation, the circuit design simulation arrangement 300 is used to generate a functional classification and related hierarchy as follows. Channel-connected regions within a particular circuit design are identified from netlist information retrieved via the netlist interface 320. Functional circuit characteristics for a particular type of circuit are input via the simulation tool 370 for use in identifying portions of the circuit design. As discussed above, these characteristics include expected response behavior of the particular type of functional circuit under different operating conditions.

The CRE 310 simulates the channel-connected regions under test conditions known to generate an expected response from the particular circuit type. Circuits that generate this expected response can thus be identified as the particular circuit type. For example, where the functional circuit to be identified is a pseudo-nMOS circuit, the CRE 310 simulates the channel-connected regions using inputs that are known to generate an expected response from a pseudo-nMOS circuit. Channel-connected regions that exhibit the expected response under the test conditions are then characterized as pseudo-nMOS circuits.

Once a particular circuit is functionally classified, other circuits from the netlist that make up the circuit are further classified and identified with hierarchical relationships by the CRE 310. For instance, as discussed above, where two or more sub-circuits (or “child” circuits) make up a larger circuit (or “parent” circuit), the sub-circuits are hierarchically related to the larger circuit. Similarly, where the sub-circuits can be further broken into additional sub-circuits, a similar hierarchical relationship is established. The hierarchical classification is carried out until circuit components that do not have a sub-component (e.g., a FET) are identified. Each of these circuit components is functionally classified by the CRE 310.

Those skilled in the art will appreciate that various alternative computing arrangements would be suitable for hosting the approaches for the different embodiments of the present invention. In addition, the approaches may be implemented via a variety of computer-readable media or delivery channels such as magnetic or optical disks or tapes, electronic storage devices, or as application services over a network.

The present invention is believed to be applicable to a variety of circuit design simulation arrangements and approaches and has been found to be particularly applicable and beneficial for use with circuit design data simulation for use with circuit recognition and verification-type implementations. In addition, the present invention is applicable to circuit partitioning approaches for a variety of applications. For general information regarding circuit partitioning, and for specific information regarding circuit partitioning approaches to which the present invention may be applicable, reference may be made to U.S. Pat. No. 6,499,129, which is fully incorporated herein by reference.

Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

What is claimed is:

1. A method for simulating a circuit design, the method comprising:
identifying charge-holding combinations of connected circuit components in a non-hierarchical representation of a circuit design as known circuit components as a function of characterized responses of the combinations, and storing identification information of the known circuit components in association with the identified charge-holding combinations;
for each of the identified charge-holding combinations, identifying sub-combinations of circuit components therein that implement a known circuit, and storing identification information of the known circuits in association with the identified sub-combinations; and
identifying and storing data descriptive of a hierarchical relationship between each identified charge-holding combination and each sub-combination of the charge-holding combination.

2. The method of claim 1, wherein identifying charge-holding combinations of connected circuit components in a non-hierarchical representation of a circuit design as known circuit components as a function of characterized responses of the combinations includes:
simulating groups of connected circuit components;
observing responses to the simulation; and
for each of the simulated groups, identifying the group as a known circuit component by correlating an observed response of the group with an expected response from a known circuit component.

3. The method of claim 1, further comprising, prior to identifying charge-holding combinations of connected circuit components, flattening a netlist representation of the circuit design into the non-hierarchical representation of a circuit design.

4. The method of claim 1, wherein identifying charge-holding combinations of connected circuit components in a non-hierarchical representation of a circuit design as known circuit components as a function of characterized responses of the combinations includes:
identifying circuit components sharing channel-connected regions; and
simulating combinations of the channel-connected components to identify combinations thereof that hold charge.

5. A method for simulating a circuit design, the method comprising:
identifying connected circuit components in a non-hierarchical representation of a circuit design;
simulating groups of the identified connected circuit components for detection of combinations of the connected circuit components that hold charge, whereby the detected combinations are identified as charge-holding combinations;
simulating each of the charge-holding combinations and characterizing responses of the charge-holding combinations under a plurality of operating conditions;
identifying each of the charge-holding combinations as a known circuit component as a function of the characterized responses, and storing identification information of the known circuit components in association with the identified charge-holding combinations;
for each of the identified charge-holding combinations, identifying sub-combinations of circuit components therein that implement a known circuit, and storing identification information of the known circuits in association with the identified sub-combinations; and
identifying and storing data descriptive of a hierarchical relationship between each identified charge-holding combination and each sub-combination of the charge-holding combination.

6. The method of claim 5, wherein identifying connected circuit components in a non-hierarchical representation of a circuit design includes identifying the connected circuit components in response to an application programming interface (API) call for returning circuit information from the circuit design.

7. The method of claim 5, further comprising, in response to an API call for circuits implementing a known circuit, returning information for all identified circuit combinations having identification information for the known circuit stored in association therewith.

8. The method of claim 7, wherein returning information for all identified circuit combinations having identification information for the known circuit stored in association therewith includes returning information in response to an API call that is devoid of location information for the circuits.

9. The method of claim 5, further comprising, in response to an API call for circuits implementing a known circuit within a specified charge-holding combination, returning information for all identified sub-combinations of the charge-holding combination that have information for the known circuit stored in association therewith.

10. The method of claim 5, further comprising flattening a netlist into said non-hierarchical representation of a circuit design.

11. The method of claim 10, wherein identifying connected circuit components includes identifying components from an output of a netlist characterization of the circuit design.

12. The method of claim 5, wherein at least one of identifying charge-holding combinations and identifying sub-combinations includes running circuit recognition on a flattened netlist.

13. The method of claim 12, wherein identifying and storing data descriptive of a hierarchical relationship between each identified charge-holding combination and each sub-combination of the charge-holding combination includes storing data descriptive of a hierarchical relationship that is different than hierarchical relationships represented in a netlist for the circuit design.

14. The method of claim 5, wherein identifying sub-combinations includes identifying all circuits of a charge-holding combination that include a FET and at least one other circuit component.

15. The method of claim 5, wherein simulating each of the charge-holding combinations and characterizing responses of the charge-holding combinations under a plurality of operating conditions includes inputting a test vector known to generate a particular response for a known circuit and, in response to a charge-holding combination exhibiting the particular response, identifying the charge-holding combination as the known circuit.

16. The method of claim 5, wherein identifying connected circuit components in a non-hierarchical representation of a circuit design includes identifying circuit components sharing channel-connected regions.

17. A system for simulating a circuit design, the system comprising:
means for identifying connected circuit components in a non-hierarchical representation of a circuit design;
means for simulating groups of the identified connected circuit components for detection of combinations of the connected circuit components that hold charge, whereby the detected combinations are identified as charge-holding combinations;
means for simulating each of the charge-holding combinations and characterizing responses of the charge-holding combinations under a plurality of operating conditions;
means for identifying each of the charge-holding combinations as a known circuit component as a function of the characterized responses, and storing identification information of the known circuit components in association with the identified charge-holding combinations;
means, for each of the identified charge-holding combinations, for identifying sub-combinations of circuit components therein that implement a known circuit, and storing identification information of the known circuits in association with the identified sub-combinations; and
means for identifying and storing data descriptive of a hierarchical relationship between each identified charge-holding combination and each sub-combination of the charge-holding combination.

18. A program storage device, comprising:
a processor-readable medium configured with instructions executable by the processor for demoting a page in virtual memory by performing the operations of:
identifying connected circuit components in a non-hierarchical representation of a circuit design;
simulating groups of the identified connected circuit components for detection of combinations of the connected circuit components that hold charge, whereby the detected combinations are identified as charge-holding combinations;
simulating each of the charge-holding combinations and characterizing responses of the charge-holding combinations under a plurality of operating conditions;
identifying each of the charge-holding combinations as a known circuit component as a function of the characterized responses, and storing identification information of the known circuit components in association with the identified charge-holding combinations;
for each of the identified charge-holding combinations, identifying sub-combinations of circuit components therein that implement a known circuit, and storing identification information of the known circuits in association with the identified sub-combinations; and
identifying and storing data descriptive of a hierarchical relationship between each identified charge-holding combination and each sub-combination of the charge-holding combination.

19. The device of claim 18, wherein the processor-readable medium is further configured with instructions executable by the processor for demoting a page in virtual memory by performing the operations of identifying connected circuit components in a non-hierarchical representation of a circuit design by identifying the connected circuit components in response to an application programming interface (API) call for returning circuit information from the circuit design.

20. The device of claim 18, wherein the processor-readable medium is further configured with instructions executable by the processor for demoting a page in virtual memory by performing the operations of, in response to an API call for circuits implementing a known circuit, returning information for all identified circuit combinations having identification information for the known circuit stored in association therewith.

21. The device of claim 20, wherein the processor-readable medium is further configured with instructions executable by the processor for demoting a page in virtual memory by performing the operations of returning information for all identified circuit combinations having identification information for the known circuit stored in association therewith by returning information in response to an API call that is devoid of location information for the circuits.

22. The device of claim 18, wherein the processor-readable medium is further configured with instructions executable by the processor for demoting a page in virtual memory by performing the operations of, in response to an API call for circuits implementing a known circuit within a specified charge-holding combination, returning information for all identified sub-combinations of the charge-holding combination that have information for the known circuit stored in association therewith.

23. The device of claim 18, wherein the processor-readable medium is further configured with instructions executable by the processor for demoting a page in virtual memory by performing the operations of flattening a netlist into said non-hierarchical representation of a circuit design.

24. The device of claim 23, wherein the processor-readable medium is further configured with instructions executable by the processor for demoting a page in virtual memory by performing the operations of identifying connected circuit components by identifying components from an output of a netlist characterization of the circuit design.

25. The device of claim 18, wherein the processor-readable medium is further configured with instructions executable by the processor for demoting a page in virtual memory by performing the operations of at least one of identifying charge-holding combinations and identifying sub-combinations by running circuit recognition on a flattened netlist.

26. The device of claim 25, wherein the processor-readable medium is further configured with instructions executable by the processor for demoting a page in virtual memory by performing the operations of identifying and storing data descriptive of a hierarchical relationship between each identified charge-holding combination and each sub-combination of the charge-holding combination by storing data descriptive of a hierarchical relationship that is different than hierarchical relationships represented in a netlist for the circuit design.

27. The device of claim 18, wherein the processor-readable medium is further configured with instructions executable by the processor for demoting a page in virtual memory by performing the operations of identifying sub-combinations by identifying all circuits of a charge-holding combination that include a FET and at least one other circuit component.

28. The device of claim 18, wherein the processor-readable medium is further configured with instructions executable by the processor for demoting a page in virtual memory by performing the operations of simulating each of the charge-holding combinations and characterizing responses of the charge-holding combinations under a plurality of operating conditions by inputting a test vector known to generate a particular response for a known circuit and, in response to a charge-holding combination exhibiting the particular response, by identifying the charge-holding combination as the known circuit.

29. The device of claim 18, wherein the processor-readable medium is further configured with instructions executable by the processor for demoting a page in virtual memory by performing the operations of identifying connected circuit components in a non-hierarchical representation of a circuit design by identifying circuit components sharing channel-connected regions.
